(19) United States
(12) Patent Application Publication
(10) Pub. No.: US 2019/0373167 A1
(43) Pub. Date: Dec. 5, 2019

(54) SPOTLIGHT DETECTION FOR IMPROVED IMAGE QUALITY

(71) Applicant: QUALCOMM Incorporated, San Diego, CA (US)

(72) Inventors: Wei-Chih Liu, Taipei City (TW); Wen-Chun Feng, Taipei (TW); Richard Chen, Arcadia, CA (US); Yu Cheng Hsieh, Taipei (TW)

(21) Appl. No.: 15/993,290

(22) Filed: May 30, 2018

(51) Int. Cl. H04N 5/232; H04N 5/243; H04N 5/235; H04N 9/73; H04N 9/64

(52) U.S. Cl. CPC H04N 5/23229; H04N 5/23293; H04N 9/646; H04N 5/2351; H04N 9/735; H04N 5/243

(57) ABSTRACT

Methods, systems, and devices for image processing are described. A device may detect a spotlight in an exposure of a scene based at least in part on one or more auto-exposure statistics for the exposure. The device may determine a lens position for a sensor of the device based at least in part on detecting the spotlight. The device may capture, by the sensor and based on the lens position, a pixel array representing the scene. The device may adjust image processing parameters of an automatic white balance stage or a contrast enhancement stage of an image processing pipeline based at least in part on the detected spotlight. The device may generate a color-corrected image by passing the pixel array through the image processing pipeline. The device may output the color-corrected image.

### BACKGROUND

The following relates generally to image processing, and more specifically to spotlight detection for improved image quality.

Spectral responses of human eyes and spectral responses of digital sensors (e.g., cameras) and/or displays may be different. Thus, properties of an image of a scene (e.g., color, saturation, brightness, contrast) may differ from a representation of the scene perceived by human eyes. For example, the human eye may constantly adjust to a broad range of luminance present in an environment, allowing the brain to interpret information in a wide range of light conditions. Similarly, devices may use image processing techniques to convert image data to various color formats and may perform various enhancements and modifications to the raw image. In some cases, these image processing techniques may be impacted by artifacts within the scene. By way of example, scenes containing bright objects (e.g., street lamps, beacons, the moon) may experience blurring, haziness, or the like when represented as a pixel array. For example, such artifacts may result at least in part from the differences between spectral responses of human eyes and spectral responses of digital sensors. Improved techniques for spotlight detection may be associated with improved image quality.

### SUMMARY

The described techniques relate to improved methods, systems, devices, and apparatuses that support spotlight detection for improved image quality. Generally, the described techniques provide for spotlight detection using auto-exposure statistics. For example, a device may detect a spotlight in a scene by using the auto-exposure statistics to detect saturated (e.g., over-exposed, bright) spots in a test scene (e.g., a preview of an exposure). When a spotlight is detected, the device may update one or more image processing modules (e.g., to improve processing of the scene). Examples of such adjustments include adjusting an auto-focus stage of the image processing pipeline, modifying an automatic white balance stage of the image processing pipeline, performing a histogram-stretching operation (e.g., to enhance contrast), or the like. The described techniques may support capturing clear (e.g., non-hazy) images with better contrast (e.g., for a moon scene, a concert scene, a night scene) than may be achievable using other techniques.

A method of image processing at a device is described. The method may include detecting a spotlight in an exposure of a scene based on one or more auto-exposure statistics for the exposure, determining a lens position for a sensor of the device based on detecting the spotlight, capturing, by the sensor and based on the lens position, a pixel array representing the scene, adjusting image processing parameters of an automatic white balance stage or a contrast enhancement stage of an image processing pipeline based on the detected spotlight, generating a color-corrected image by passing the pixel array through the image processing pipeline, and outputting the color-corrected image.

An apparatus for image processing is described. The apparatus may include a processor, memory in electronic communication with the processor, and instructions stored in the memory. The instructions may be executable by the processor to cause the apparatus to detect a spotlight in an exposure of a scene based on one or more auto-exposure statistics for the exposure, determine a lens position for a sensor of the apparatus based on detecting the spotlight, capture, by the sensor and based on the lens position, a pixel array representing the scene, adjust image processing parameters of an automatic white balance stage or a contrast enhancement stage of an image processing pipeline based on the detected spotlight, generate a color-corrected image by passing the pixel array through the image processing pipeline, and output the color-corrected image.

Another apparatus for image processing is described. The apparatus may include means for detecting a spotlight in an exposure of a scene based on one or more auto-exposure statistics for the exposure, determining a lens position for a sensor of the apparatus based on detecting the spotlight, capturing, by the sensor and based on the lens position, a pixel array representing the scene, adjusting image processing parameters of an automatic white balance stage or a contrast enhancement stage of an image processing pipeline based on the detected spotlight, generating a color-corrected image by passing the pixel array through the image processing pipeline, and outputting the color-corrected image.

A non-transitory computer-readable medium storing code for image processing at a device is described. The code may include instructions executable by a processor to detect a spotlight in an exposure of a scene based on one or more auto-exposure statistics for the exposure, determine a lens position for a sensor of the device based on detecting the spotlight, capture, by the sensor and based on the lens position, a pixel array representing the scene, adjust image processing parameters of an automatic white balance stage or a contrast enhancement stage of an image processing pipeline based on the detected spotlight, generate a color-corrected image by passing the pixel array through the image processing pipeline, and output the color-corrected image.

Some examples of the method, apparatuses, and non-transitory computer-readable medium described herein may further include operations, features, means, or instructions for generating a preview of the exposure based on the lens position and displaying the preview of the exposure prior to capturing the pixel array.

In some examples of the method, apparatuses, and non-transitory computer-readable medium described herein, generating the preview of the exposure may include operations, features, means, or instructions for applying an automatic white balance operation or a contrast enhancement operation to the exposure of the scene.

In some examples of the method, apparatuses, and non-transitory computer-readable medium described herein, at least one parameter of the automatic white balance operation or the contrast enhancement operation may be based on detecting the spotlight.

In some examples of the method, apparatuses, and non-transitory computer-readable medium described herein, detecting the spotlight may include operations, features, means, or instructions for dividing the exposure of the scene into a set of regions, each region including a respective set of pixels, determining at least one auto-exposure statistic for each region and comparing each auto-exposure statistic to a threshold, where the spotlight may be detected based on the comparing.

In some examples of the method, apparatuses, and non-transitory computer-readable medium described herein, adjusting the image processing parameters of the white balance stage may include operations, features, means, or instructions for identifying, based on the comparing, a region of the set of regions that contains the spotlight, generating a second pixel array by removing the region that contains the spotlight from the pixel array and performing a white balance operation on the second pixel array, where the color-corrected image may be generated based on the white balance operation.

In some examples of the method, apparatuses, and non-transitory computer-readable medium described herein, the at least one auto-exposure statistic for each region includes a percentage of saturated pixels in the region, an average Luma value for the pixels in the region, or a combination thereof.

In some examples of the method, apparatuses, and non-transitory computer-readable medium described herein, adjusting the image processing parameters of the contrast enhancement stage may include operations, features, means, or instructions for generating a pixel distribution for the pixel array, where the pixel distribution indicates a number of pixels having respective brightnesses across a first range of brightnesses and updating pixel values for one or more pixels of the pixel array by stretching the pixel distribution across a second range of brightnesses, the second range of brightnesses greater than the first range of brightnesses, where the color-corrected image may be generated based on the updated pixel values.

In some examples of the method, apparatuses, and non-transitory computer-readable medium described herein, determining the lens position for the sensor may include operations, features, means, or instructions for adjusting one or more parameters of a focus value operation, where the lens position of the sensor may be determined based on the adjusting.

In some examples of the method, apparatuses, and non-transitory computer-readable medium described herein, the one or more parameters of the focus value operation includes a focus value maximum threshold, a focus value minimum threshold, a focus value bandpass filter, or a combination thereof.

In some examples of the method, apparatuses, and non-transitory computer-readable medium described herein, outputting the color-corrected image may include operations, features, means, or instructions for writing the color-corrected image to a memory component of the device, displaying the color-corrected image; or and transmitting the color-corrected image to a second device.

### BRIEF DESCRIPTION OF THE DRAWINGS

FIG. 1 illustrates an example of a pixel array that supports spotlight detection for improved image quality in accordance with aspects of the present disclosure.

FIG. 2 illustrates an example of a process flow that supports spotlight detection for improved image quality in accordance with aspects of the present disclosure.

FIGS. 3A and 3B illustrate example focal value operations that support spotlight detection for improved image quality in accordance with aspects of the present disclosure.

FIG. 4 illustrates an example of a contrast enhancement operation that supports spotlight detection for improved image quality in accordance with aspects of the present disclosure.

FIG. 5 shows a block diagram of a device that supports spotlight detection for improved image quality in accordance with aspects of the present disclosure.

FIG. 6 shows a diagram of a system including a device that supports spotlight detection for improved image quality in accordance with aspects of the present disclosure.

FIGS. 7 through 9 show flowcharts illustrating methods that support spotlight detection for improved image quality in accordance with aspects of the present disclosure.

### DETAILED DESCRIPTION

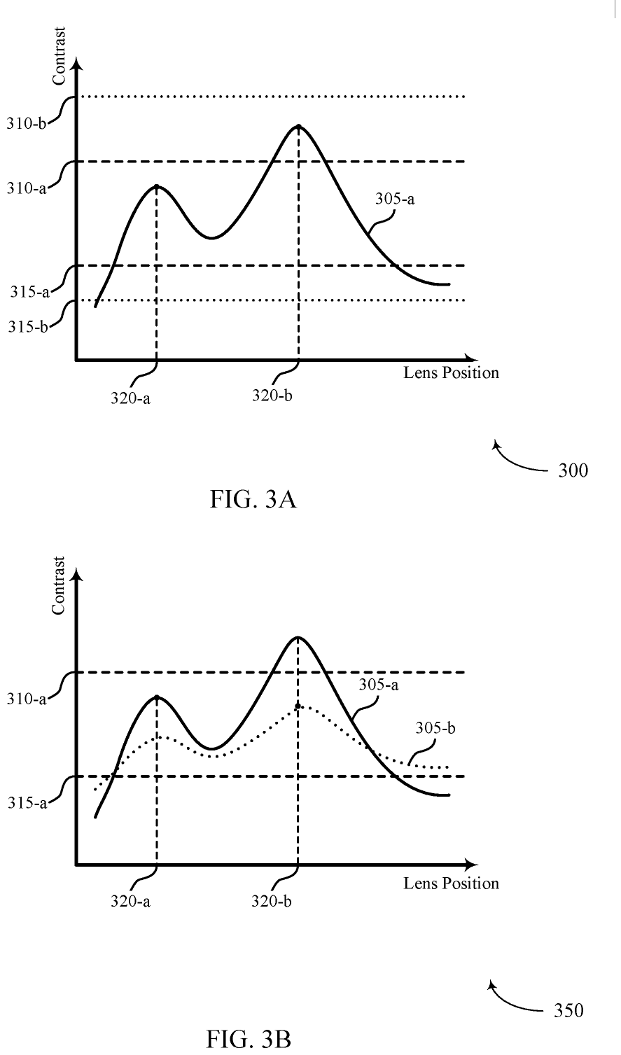

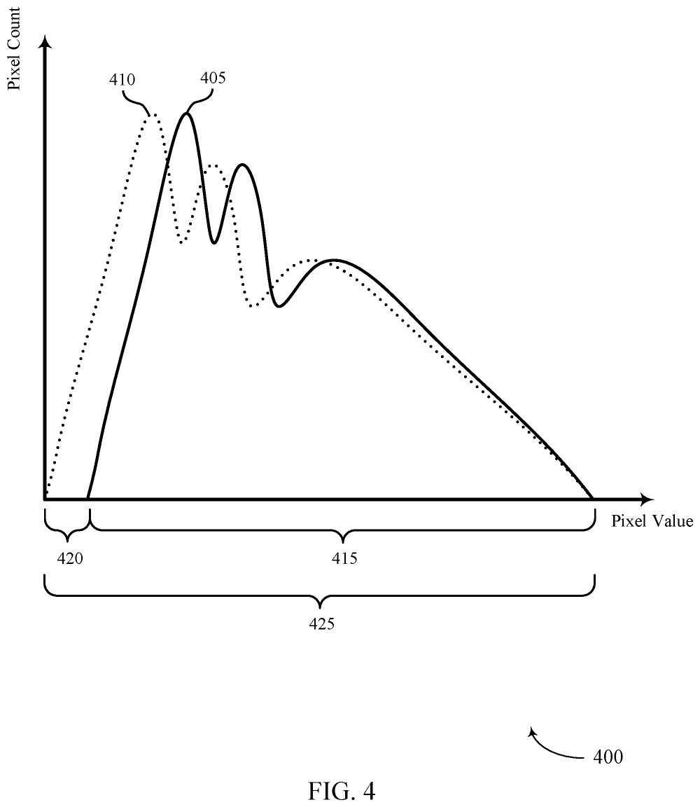

Some devices may support image processing techniques (e.g., automatic adjustments) to provide for better image quality. For example, such image processing adjustments may be designed to approximate spectral responses of the human eye. An example of such a response is the ability of the human eye to constantly adjust to a broad range of luminance present in an environment, allowing the brain to interpret information in a wide range of light conditions. Aspects of the following relate to spotlight detection using auto-exposure statistics and resulting improvements in image quality. For example, a device operating in accordance with aspects of the present disclosure may detect a spotlight in an exposure of a scene (e.g., based on saturated pixel percentage information, average brightness information) and adjust one or more image processing parameters to account for the detected spotlight. Example adjustments include adjusting a distribution of pixel values (e.g., as described with reference to FIG. 4), adjustment of a focusing operation (e.g., as described with reference to FIGS. 3A and 3B), adjustment of a white balance operation, etc.

Aspects of the disclosure are initially described in the context of a wireless communications system. Aspects of the disclosure are further illustrated by and described with reference to apparatus diagrams, system diagrams, and flowcharts that relate to spotlight detection for improved image quality.

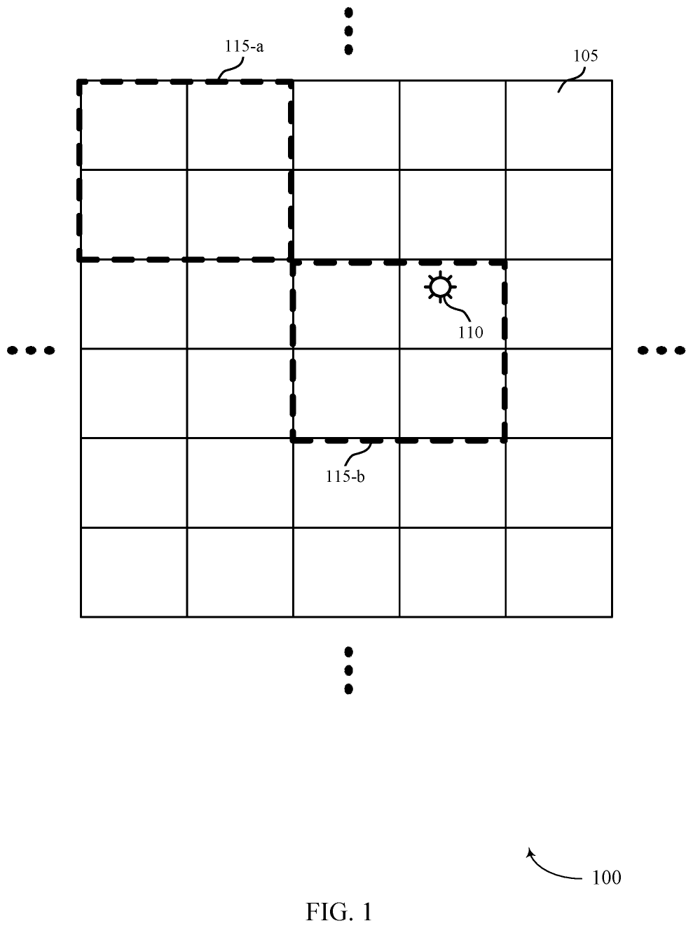

FIG. 1 illustrates an example of a pixel array 100 that supports spotlight detection for improved image quality in accordance with aspects of the present disclosure. For example, pixel array 100 may be obtained by a device, such as a mobile device, using a sensor and may be processed by the device (e.g., by an image signal processor). A mobile device may also be referred to as a user equipment (UE), a wireless device, a remote device, a handheld device, or a subscriber device, or some other suitable terminology, where the “device” may also be referred to as a unit, a station, a terminal, or a client. A mobile device may be a personal electronic device such as a cellular phone, a personal digital assistant (PDA), a tablet computer, a laptop computer, or a personal computer. In some examples, a mobile device may also refer to a wireless local loop (WLL) station, an Internet of Things (IoT) device, an Internet of Everything (IoE) device, a machine type communication (MTC) device, or the like, which may be implemented in various articles such as appliances, vehicles, meters, or some other suitable terminology.

Pixel array 100 comprises a plurality of pixels 105 organized into a grid. It is to be understood that pixel array 100 may contain any number of pixels without deviating from the scope of the present disclosure. Each pixel 105 may be represented digitally by a number of bits, where the number of bits per pixel 105 may determine the dynamic range of pixel array 100. In some cases pixel array 100 may be a digital representation of a spotlight scene such as a moon scene, a concert scene, a night scene, or the like. For example, pixel array 100 may include spotlight 110. It is to be understood that, though described as a light source, spotlight 110 may in some cases be a reflector of a light (e.g., a mirror, a window, the moon) without deviating from the scope of the present disclosure. Additionally or alternatively, though shown as being contained in a single pixel 105, it is to be understood that spotlight 110 may in some cases span multiple pixels 105 within pixel array 100.

In accordance with aspects of the present disclosure, a device may detect a presence of spotlight 110 in pixel array 100. For example, the detection of spotlight 110 may be based at least in part on the use of auto-exposure statistics in accordance with aspects of the present disclosure. A device may divide pixel array 100 into regions 115, where each region 115 includes a plurality of pixels 105. Although shown as having equal sizes, it is to be understood that in some cases the size of regions 115 may vary across pixel array 100 (e.g., may be larger at the edges of the pixel array, may follow some other pattern, etc.). Aspects of regions 115 (e.g., a pattern, a size, etc.) may in some cases be variable (e.g., based on some configuration). Generally, the device may use the auto-exposure statistics to detect spotlight 110 based on pixel saturation (e.g., or luminance) information associated with pixel array 100.

By way of example, the device may divide pixel array 100 into regions 115. The device may then determine a value for each region 115 representing the brightness of the region 115. For example, the device may identify a percentage of saturated pixels 105 in each region 115 (e.g., a percentage of pixels 105 in each region 115 having a brightness above some value). Additionally or alternatively, the device may identify an average Luma value for each region 115 (e.g., an average of the brightness values for pixels 105 in a region 115). More generally, the device may identify a percentage of pixels 105 in each region 115 having a brightness above some value and/or an aggregate brightness for the region 115 as a whole (e.g., the average Luma value). Such metrics may provide different information such that the use of one or both may provide more robust detection of a spotlight 110.

The device may detect spotlight 110 based on processing the regions 115. For example, the device may determine that region 115-a does not contain a spotlight 110 because the average Luma value for region 115-a is below a threshold or the like. Alternatively, the device may determine that region 115-b contains spotlight 110 based on the average Luma value for region 115-b satisfying the threshold, based on the percentage of saturated pixels 105 in region 115-b, or the like. By way of example, the pixel 105 illustrated as containing spotlight 110 may represent a saturated pixel such that the saturated percentage of region 115-b may be 25%. As discussed above, spotlight 110 may in some cases span multiple pixels 105.

Upon detecting the spotlight 110, the device may perform one or more adjustments to various image processing modules. For example, the device may adjust a lens position, an automatic white-balance operation, a contrast enhancement operation, etc. For example, the automatic white-balance operation adjustment may include removing spotlight 110 (e.g., removing region 115-b, removing saturated pixels 105) from a white balance computation.

In some cases, the device may detect spotlight 110 in a preview of the scene (e.g., which preview may in some cases be displayed to a user of the device). Upon detecting the spotlight, the device may adjust the image processing parameters such that the adjustments are reflected in subsequent previews. That is, the detection of spotlight 110 in pixel array 100 may impact the processing of subsequent pixel arrays 100 containing spotlight 110. Such impacts may apply even if the sensor of the device moves (e.g., jitters) as long as the spotlight 110 remains somewhere in the captured image.

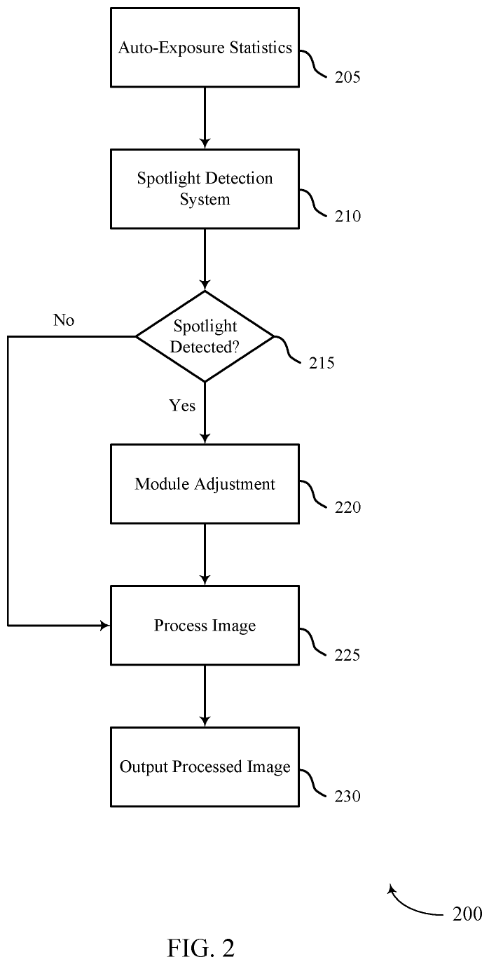

FIG. 2 illustrates an example of a process flow 200 that supports spotlight detection for improved image quality in accordance with aspects of the present disclosure. For example, process flow 200 may be implemented by a mobile device as described with reference to FIG. 1.

At 205, the device may identify or compute auto-exposure statistics for a given scene. For example, the device may be operating in an auto-exposure mode or otherwise configured to identify the correct exposure for the scene (e.g., without additional input from a user of the device). Examples of auto-exposure statistics include contrast, saturation, brightness, etc.

At 210, the auto-exposure statistics may be fed to a spotlight detection system. For example, the spotlight detection system may operate according to techniques described with reference to FIG. 1. That is, the spotlight detection system may divide the scene into multiple regions and iteratively (e.g., or otherwise) process the regions to detect a spotlight 110.

At 215, the device may determine whether the output of the spotlight detection system satisfies a spotlight detection threshold (e.g., a configurable threshold, a static threshold). For example, the device may compare the average Luma value of the regions to the spotlight detection threshold.

If a spotlight is detected, the device may perform one or more module adjustments at 220. For example, the device may adjust a lens position of a sensor, may adjust a white balance operation, may use a histogram stretch operation (e.g., to improve contrast). If a spotlight is not detected (e.g., or was previously detected and accommodated for), the device may skip 220 and proceed to processing the image at 225. Processing the image may include passing the image through an image processing pipeline that comprises the histogram stretch operation, the white balance operation, or the like.

At 230, the device may output the processed image. In some cases, outputting the processed image may include displaying the processed image (e.g., as a preview for a user of the device). Additionally or alternatively, outputting the processed image may include storing the image to a memory of the device, transmitting the image to another device, or the like.

FIG. 3A illustrates an example of a focal value operation 300 that supports spotlight detection for improved image quality in accordance with aspects of the present disclosure. For example, focal value operation 300 may be performed by a device as described with reference to FIG. 1. In some cases, focal value operation 300 may be performed based at least in part on the device detecting a spotlight in an image.

Focal value operation 300 includes contrast curve 305-a, which illustrates image contrast as a function of lens position. In some cases, focal value operation 300 may be based on detecting a peak in contrast curve 305-a (e.g., a local maximum). Focal value operation 300 may be based on a focal value maximum 310 and a focal value minimum 315, which may effectively define a focal value search range for focal value operation 300.

As an example, focal value operation 300 may be associated with a default focal value maximum 310-a and a default focal value minimum 315-a. Based on this search range, a device may identify lens position 320-a (e.g., based on the local maximum of contrast curve 305-a within the search range). However, in some cases, the correct lens position 320-b may correspond to a point of contrast curve 305-a that is outside of the default search range. In accordance with aspects of the present disclosure, a device may adjust the search range of focal value operation 300 based on detecting a spotlight in an exposure of a scene. For example, the device may increase focal value maximum 315-a to focal value maximum 315-b, may decrease focal value minimum 315-a to focal value minimum 315-b, both, or otherwise adjust the search range (e.g., adjust the focal value bandpass filter). Based on the adjustment, the device may be able to identify correct lens position 320-b. That is, the described techniques may provide for stricter peak recognition during an auto-focus scan (e.g., which may allow the device to ignore lens position 320-a). Use of correct lens position 320-b may provide a less blurry image or otherwise improve image quality.

FIG. 3B illustrates an example of a focal value operation 350 that supports spotlight detection for improved image quality in accordance with aspects of the present disclosure. For example, focal value operation 350 may be performed by a device as described with reference to FIG. 1. In some cases, focal value operation 350 may be performed based at least in part on the device detecting a spotlight in an image.

Focal value operation 350 may be used in addition to (e.g., or instead of) focal value operation 300 to identify correct lens position 320-b. While focal value operation 300 may adjust a focal value search range, focal value operation 350 may adjust parameters that impact generation of contrast curve 305. For example, the adjustment may result in generation of contrast curve 305-b (e.g., which may represent a compressed or otherwise adjusted version of contrast curve 305-a). As illustrated, contrast curve 305-b may not exceed focal value maximum 310-a (e.g., such that correct lens position 320-b may be selected over lens position 320-a).

FIG. 4 illustrates an example of a contrast enhancement operation 400 that supports spotlight detection for improved image quality in accordance with aspects of the present disclosure. For example, contrast enhancement operation 400 may be performed by a device as described with reference to FIG. 1. In some cases, contrast enhancement operation 400 may be performed based at least in part on the device detecting a spotlight in an image.

Contrast enhancement operation 400 includes distribution curve 405, which represents the number of pixels in a pixel array having a given pixel value (e.g., a given brightness, a given Luma value). Though illustrated as a continuous curve, it is to be understood that in some cases distribution curve 405 may be or include a histogram (e.g., such that contrast enhancement operation 400 may in some cases be referred to as a histogram stretching operation).

As illustrated, distribution curve 405 may span a first range of brightnesses 415 which may not include range 420. For example, range 420 may include a lowest portion of brightnesses (e.g., which may not be present because of the presence of a spotlight). In accordance with aspects of the present disclosure, a device may stretch distribution curve 405 to generate updated distribution curve 410. As illustrated, updated distribution curve 410 may span a second range of brightnesses 425 which includes the first range of brightnesses 415 and range 420. For example, contrast enhancement operation 400 may improve quality of an image (e.g., by de-flaring the image).

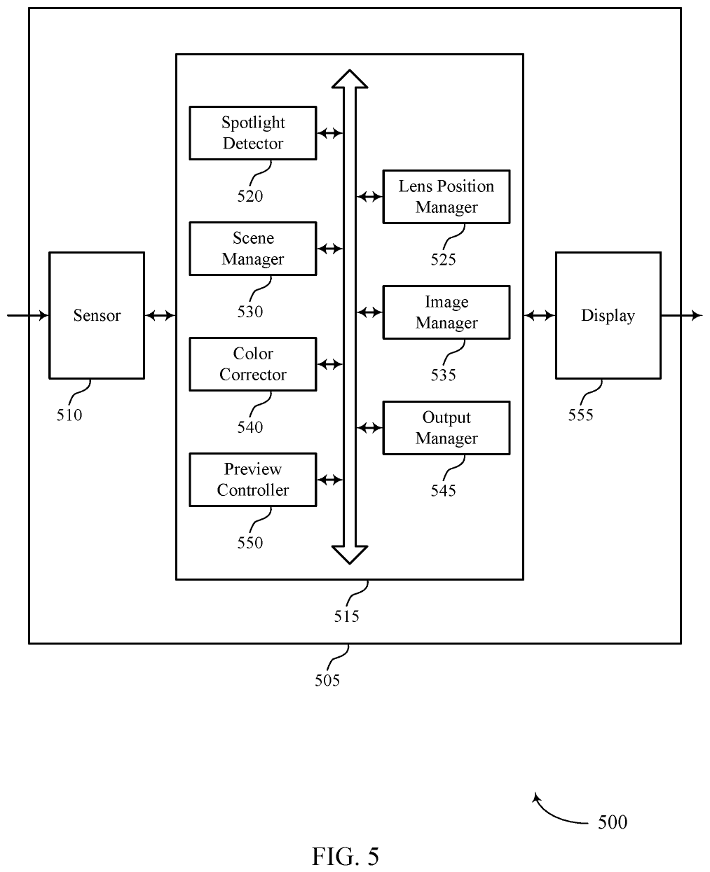

FIG. 5 shows a block diagram 500 of a device 505 that supports spotlight detection for improved image quality in accordance with aspects of the present disclosure. Device 505 may include sensor 510, image processing controller 515, and display 555. Device 505 may also include a processor. Each of these components may be in communication with one another (e.g., via one or more buses).

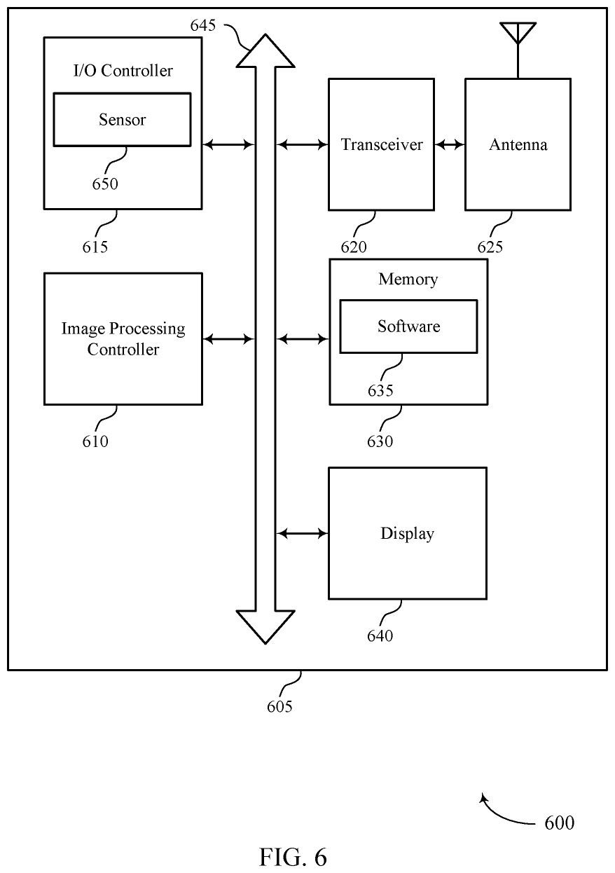

Sensor 510 may include or be an example of a digital imaging sensor for taking photos and video. In some examples, sensor 510 may receive information such as packets, user data, or control information associated with various information channels (e.g., from a transceiver 620 described with reference to FIG. 6). Information may be passed on to other components of the device. Additionally or alternatively, components of device 505 used to communicate data over a wireless (e.g., or wired) link may be in communication with image processing controller 515 (e.g., via one or more buses) without passing information through sensor 510.

The image processing controller 515 may be an example of aspects of the image processing controller 610 described with reference to FIG. 6. The image processing controller 515, and/or at least some of its sub-components, may be implemented in hardware, code (e.g., software or firmware) executed by a processor, or any combination thereof. If implemented in code executed by a processor, the functions of the image processing controller 515, and/or at least some of its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The image processing controller 515, and/or at least some of its sub-components, may be physically located at various positions, including being distributed such that portions of functions are implemented at different physical locations by one or more physical components. In some examples, the image processing controller 515, and/or at least some of its sub-components, may be a separate and distinct component in accordance with various aspects of the present disclosure. In some examples, the image processing controller 515, and/or at least some of its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The image processing controller 515 may include a spotlight detector 520, a lens position manager 525, a scene manager 530, an image manager 535, a color corrector 540, an output manager 545, and a preview controller 550. Each of these modules may communicate, directly or indirectly, with one another (e.g., via one or more buses).

The spotlight detector 520 may detect a spotlight in an exposure of a scene based on one or more auto-exposure statistics for the exposure. In some examples, the spotlight detector 520 may divide the exposure of the scene into a set of regions, each region including a respective set of pixels. In some examples, the spotlight detector 520 may determine at least one auto-exposure statistic for each region. In some examples, the spotlight detector 520 may compare each auto-exposure statistic to a threshold, where the spotlight is detected based on the comparing. In some examples, the spotlight detector 520 may identify, based on the comparing, a region of the set of regions that contains the spotlight. In some cases, the at least one auto-exposure statistic for each region includes a percentage of saturated pixels in the region, an average Luma value for the pixels in the region, or a combination thereof.

The lens position manager 525 may determine a lens position for sensor 510 based on detecting the spotlight. In some examples, the lens position manager 525 may adjust one or more parameters of a focus value operation, where the lens position of sensor 510 is determined based on the adjusting. In some cases, the one or more parameters of the focus value operation includes a focus value maximum threshold, a focus value minimum threshold, a focus value bandpass filter, or a combination thereof (e.g., as described with reference to FIGS. 3A and 3B).

The scene manager 530 may capture (e.g., via sensor 510 and based on the lens position) a pixel array representing the scene. For example, the pixel array may be an example of the pixel array described with reference to FIG. 1. The pixel array may be stored in memory of device 505 while the exposure of the scene (e.g., which is used by spotlight detector 520) may be a more transient representation of the scene (e.g., may be used to determine a lens position but may not be stored in a memory component of device 505.

The image manager 535 may adjust image processing parameters of an automatic white balance stage or a contrast enhancement stage of an image processing pipeline based on the detected spotlight. In some examples, the image manager 535 may generate a second pixel array by removing the region that contains the spotlight from the pixel array. In some examples, the image manager 535 may perform a white balance operation on the second pixel array, where the color-corrected image is generated based on the white balance operation. In some examples, the image manager 535 may generate a pixel distribution for the pixel array, where the pixel distribution indicates a number of pixels having respective brightnesses across a first range of brightnesses. In some examples, the image manager 535 may update pixel values for one or more pixels of the pixel array by stretching the pixel distribution across a second range of brightnesses, the second range of brightnesses greater than the first range of brightnesses (e.g., as described with reference to FIG. 4).

The color corrector 540 may generate a color-corrected image by passing the pixel array through the image processing pipeline. Examples of operations that may be performed by the image processing pipeline include a white balance operation, application of a color correction matrix, tone-mapping, etc.

The output manager 545 may output the color-corrected image. In some examples, the output manager 545 may write the color-corrected image to a memory component of the device. In some examples, the output manager 545 may display the color-corrected image. In some examples, the output manager 545 may transmit the color-corrected image to a second device.

The preview controller 550 may generate a preview of the exposure based on the lens position. In some examples, the preview controller 550 may display (e.g., via display 555) the preview of the exposure prior to capturing the pixel array. In some examples, the preview controller 550 may apply an automatic white balance operation or a contrast enhancement operation to the exposure of the scene. In some cases, at least one parameter of the automatic white balance operation or the contrast enhancement operation is based on detecting the spotlight.

Display 555 may be a touchscreen, a light emitting diode (LED), a monitor, etc. In some cases, display 555 may be replaced by system memory. That is, in some cases in addition to (or instead of) being displayed by device 505, the processed image may be stored in a memory of device 505.

FIG. 6 shows a diagram of a system 600 including a device 605 that supports spotlight detection for improved image quality in accordance with aspects of the present disclosure. The device 605 may be an example of or include the components of device 505. The device 605 may include components for bi-directional voice and data communications including components for transmitting and receiving communications, including an image processing controller 610, an I/O controller 615, a transceiver 620, antenna 625, memory 630, and a processor 640. These components may be in electronic communication via one or more buses (e.g., bus 645).

The image processing controller 610 may include an intelligent hardware device, (e.g., a general-purpose processor, a DSP, an image signal processor (ISP), a central processing unit (CPU), a graphics processing unit (GPU), a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting spotlight detection for improved image quality).

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615. In some cases, I/O controller 615 may be or include sensor 650. Sensor 650 may be an example of a digital imaging sensor for taking photos and video. For example, sensor 650 may represent a camera operable to obtain a raw image of a scene, which raw image may be processed by image processing controller 610 according to aspects of the present disclosure.

The transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas. In some cases, the wireless device may include a single antenna 625. However, in some cases the device may have more than one antenna 625, which may be capable of concurrently transmitting or receiving multiple wireless transmissions.

Device 605 may participate in a wireless communications system (e.g., may be an example of a mobile device). A mobile device may also be referred to as a UE, a wireless device, a remote device, a handheld device, or a subscriber device, or some other suitable terminology, where the “device” may also be referred to as a unit, a station, a terminal, or a client. A mobile device may be a personal electronic device such as a cellular phone, a PDA, a tablet computer, a laptop computer, or a personal computer. In some examples, a mobile device may also refer to an IoT device, an IoE device, a MTC device, or the like, which may be implemented in various articles such as appliances, vehicles, meters, or the like.

Memory 630 may comprise one or more computer-readable storage media. Examples of memory 630 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. Memory 630 may store program modules and/or instructions that are accessible for execution by image processing controller 610. That is, memory 630 may store computer-readable, computer-executable software 635 including instructions that, when executed, cause the processor to perform various functions described herein. In some cases, the memory 630 may contain, among other things, a basic input/output system (BIOS) which may control basic hardware or software operation such as the interaction with peripheral components or devices. The software 635 may include code to implement aspects of the present disclosure, including code to support spotlight detection for improved image quality. Software 635 may be stored in a non-transitory computer-readable medium such as system memory or other memory. In some cases, the software 635 may not be directly executable by the processor but may cause a computer (e.g., when compiled and executed) to perform functions described herein.

Display 640 represents a unit capable of displaying video, images, text or any other type of data for consumption by a viewer. Display 640 may include a liquid-crystal display (LCD), a LED display, an organic LED (OLED), an active-matrix OLED (AMOLED), or the like. In some cases, display 640 and I/O controller 615 may be or represent aspects of a same component (e.g., a touchscreen) of device 605.

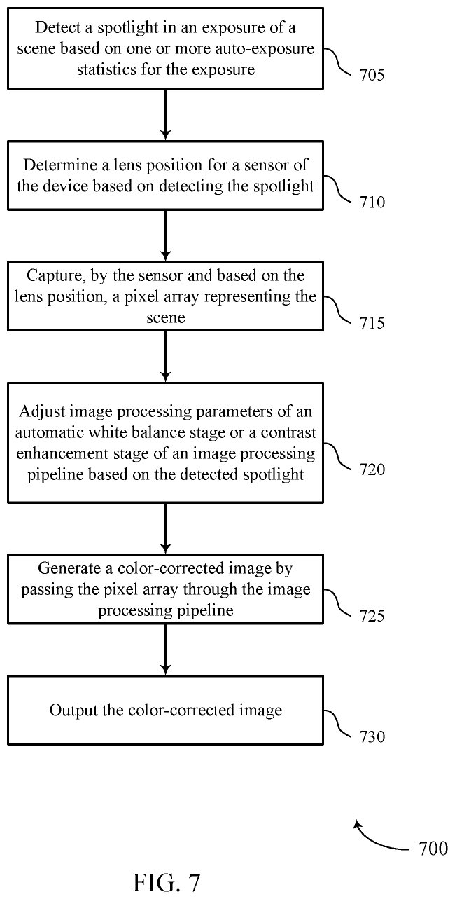

FIG. 7 shows a flowchart illustrating a method 700 that supports spotlight detection for improved image quality in accordance with aspects of the present disclosure. The operations of method 700 may be implemented by a device or its components as described herein. For example, the operations of method 700 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 705, the device may detect a spotlight in an exposure of a scene based on one or more auto-exposure statistics for the exposure. The operations of 705 may be performed according to the methods described herein. In some examples, aspects of the operations of 705 may be performed by a spotlight detector as described with reference to FIG. 5.

At 710, the device may determine a lens position for a sensor of the device based on detecting the spotlight. The operations of 710 may be performed according to the methods described herein. In some examples, aspects of the operations of 710 may be performed by a lens position manager as described with reference to FIG. 5.

At 715, the device may capture, by the sensor and based on the lens position, a pixel array representing the scene. The operations of 715 may be performed according to the methods described herein. In some examples, aspects of the operations of 715 may be performed by a scene manager as described with reference to FIG. 5.

At 720, the device may adjust image processing parameters of an automatic white balance stage or a contrast enhancement stage of an image processing pipeline based on the detected spotlight. The operations of 720 may be performed according to the methods described herein. In some examples, aspects of the operations of 720 may be performed by an image manager as described with reference to FIG. 5.

At 725, the device may generate a color-corrected image by passing the pixel array through the image processing pipeline. The operations of 725 may be performed according to the methods described herein. In some examples, aspects of the operations of 725 may be performed by a color corrector as described with reference to FIG. 5.

At 730, the device may output the color-corrected image. The operations of 730 may be performed according to the methods described herein. In some examples, aspects of the operations of 730 may be performed by an output manager as described with reference to FIG. 5.

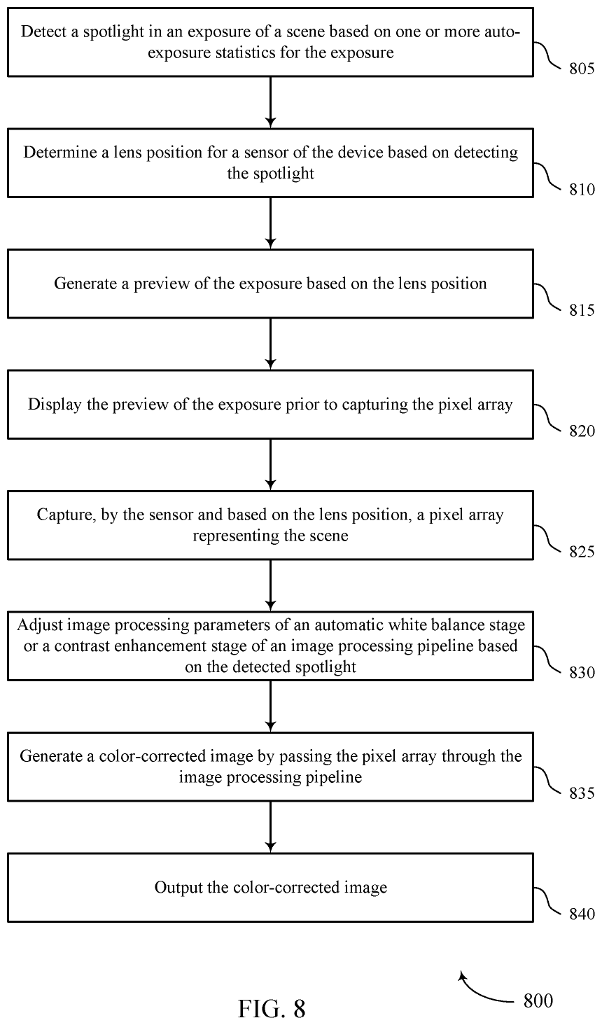

FIG. 8 shows a flowchart illustrating a method 800 that supports spotlight detection for improved image quality in accordance with aspects of the present disclosure. The operations of method 800 may be implemented by a device or its components as described herein. For example, the operations of method 800 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 805, the device may detect a spotlight in an exposure of a scene based on one or more auto-exposure statistics for the exposure. The operations of 805 may be performed according to the methods described herein. In some examples, aspects of the operations of 805 may be performed by a spotlight detector as described with reference to FIG. 5.

At 810, the device may determine a lens position for a sensor of the device based on detecting the spotlight. The operations of 810 may be performed according to the methods described herein. In some examples, aspects of the operations of 810 may be performed by a lens position manager as described with reference to FIG. 5.

At 815, the device may generate a preview of the exposure based on the lens position. The operations of 815 may be performed according to the methods described herein. In some examples, aspects of the operations of 815 may be performed by a preview controller as described with reference to FIG. 5.

At 820, the device may display the preview of the exposure prior to capturing the pixel array. The operations of 820 may be performed according to the methods described herein. In some examples, aspects of the operations of 820 may be performed by a preview controller as described with reference to FIG. 5.

At 825, the device may capture, by the sensor and based on the lens position, a pixel array representing the scene. The operations of 825 may be performed according to the methods described herein. In some examples, aspects of the operations of 825 may be performed by a scene manager as described with reference to FIG. 5.

At 830, the device may adjust image processing parameters of an automatic white balance stage or a contrast enhancement stage of an image processing pipeline based on the detected spotlight. The operations of 830 may be performed according to the methods described herein. In some examples, aspects of the operations of 830 may be performed by an image manager as described with reference to FIG. 5.

At 835, the device may generate a color-corrected image by passing the pixel array through the image processing pipeline. The operations of 835 may be performed according to the methods described herein. In some examples, aspects of the operations of 835 may be performed by a color corrector as described with reference to FIG. 5.

At 840, the device may output the color-corrected image. The operations of 840 may be performed according to the methods described herein. In some examples, aspects of the operations of 840 may be performed by an output manager as described with reference to FIG. 5.

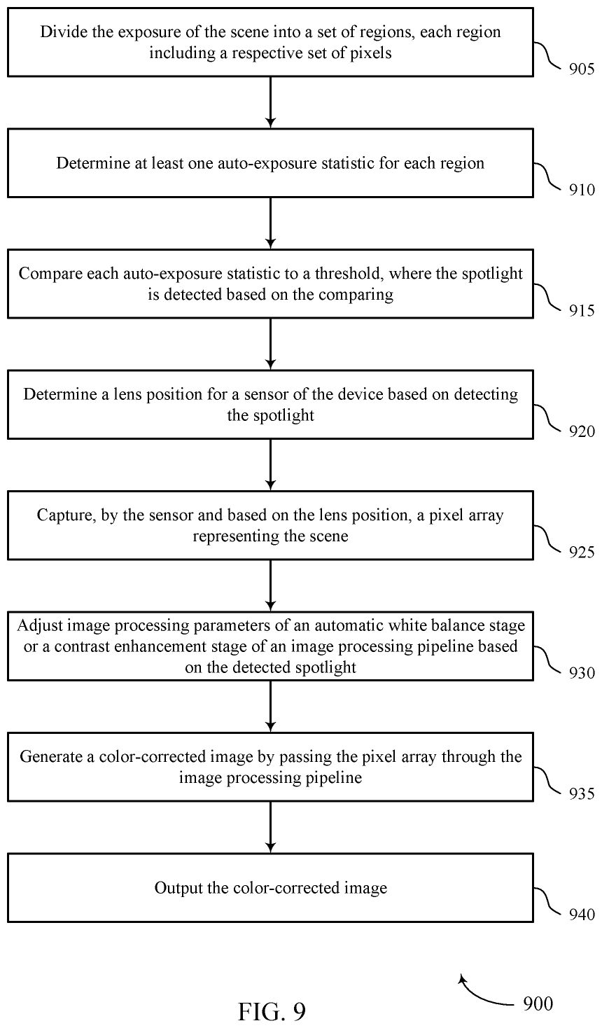

FIG. 9 shows a flowchart illustrating a method 900 that supports spotlight detection for improved image quality in accordance with aspects of the present disclosure. The operations of method 900 may be implemented by a device or its components as described herein. For example, the operations of method 900 may be performed by an image processing controller as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 905, the device may divide the exposure of the scene into a set of regions, each region including a respective set of pixels. The operations of 905 may be performed according to the methods described herein. In some examples, aspects of the operations of 905 may be performed by a spotlight detector as described with reference to FIG. 5.

At 910, the device may determine at least one auto-exposure statistic for each region. The operations of 910 may be performed according to the methods described herein. In some examples, aspects of the operations of 910 may be performed by a spotlight detector as described with reference to FIG. 5.

At 915, the device may compare each auto-exposure statistic to a threshold, where the spotlight is detected based on the comparing. The operations of 915 may be performed according to the methods described herein. In some examples, aspects of the operations of 915 may be performed by a spotlight detector as described with reference to FIG. 5.

At 920, the device may determine a lens position for a sensor of the device based on detecting the spotlight. The operations of 920 may be performed according to the methods described herein. In some examples, aspects of the operations of 920 may be performed by a lens position manager as described with reference to FIG. 5.

At 925, the device may capture, by the sensor and based on the lens position, a pixel array representing the scene. The operations of 925 may be performed according to the methods described herein. In some examples, aspects of the operations of 925 may be performed by a scene manager as described with reference to FIG. 5.

At 930, the device may adjust image processing parameters of an automatic white balance stage or a contrast enhancement stage of an image processing pipeline based on the detected spotlight. The operations of 930 may be performed according to the methods described herein. In some examples, aspects of the operations of 930 may be performed by an image manager as described with reference to FIG. 5.

At 935, the device may generate a color-corrected image by passing the pixel array through the image processing pipeline. The operations of 935 may be performed according to the methods described herein. In some examples, aspects of the operations of 935 may be performed by a color corrector as described with reference to FIG. 5.

At 940, the device may output the color-corrected image. The operations of 940 may be performed according to the methods described herein. In some examples, aspects of the operations of 940 may be performed by an output manager as described with reference to FIG. 5.

It should be noted that the methods described above describe possible implementations, and that the operations and the steps may be rearranged or otherwise modified and that other implementations are possible. Further, aspects from two or more of the methods may be combined. In some cases, one or more operations described above (e.g., with reference to FIGS. 7 through 9) may be omitted or adjusted without deviating from the scope of the present disclosure. Thus the methods described above are included for the sake of illustration and explanation and are not limiting of scope.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
detecting a spotlight in an exposure of a scene based at least in part on one or more auto-exposure statistics for the exposure;
determining a lens position for a sensor of the device based at least in part on detecting the spotlight;
capturing, by the sensor and based on the lens position, a pixel array representing the scene;
adjusting image processing parameters of an automatic white balance stage or a contrast enhancement stage of an image processing pipeline based at least in part on the detected spotlight;
generating a color-corrected image by passing the pixel array through the image processing pipeline; and
outputting the color-corrected image.

2. The method of claim 1, further comprising:
generating a preview of the exposure based at least in part on the lens position; and
displaying the preview of the exposure prior to capturing the pixel array.

3. The method of claim 2, wherein generating the preview of the exposure comprises:
applying an automatic white balance operation or a contrast enhancement operation to the exposure of the scene.

4. The method of claim 3, wherein at least one parameter of the automatic white balance operation or the contrast enhancement operation is based at least in part on detecting the spotlight.

5. The method of claim 1, wherein detecting the spotlight comprises:
dividing the exposure of the scene into a plurality of regions, each region comprising a respective set of pixels;
determining at least one auto-exposure statistic for each region; and
comparing each auto-exposure statistic to a threshold, wherein the spotlight is detected based at least in part on the comparing.

6. The method of claim 5, wherein adjusting the image processing parameters of the white balance stage comprises:
identifying, based at least in part on the comparing, a region of the plurality of regions that contains the spotlight;
generating a second pixel array by removing the region that contains the spotlight from the pixel array; and
performing a white balance operation on the second pixel array, wherein the color-corrected image is generated based at least in part on the white balance operation.

7. The method of claim 5, wherein the at least one auto-exposure statistic for each region comprises a percentage of saturated pixels in the region, an average Luma value for the pixels in the region, or a combination thereof.

8. The method of claim 1, wherein adjusting the image processing parameters of the contrast enhancement stage comprises:
generating a pixel distribution for the pixel array, wherein the pixel distribution indicates a number of pixels having respective brightnesses across a first range of brightnesses; and
updating pixel values for one or more pixels of the pixel array by stretching the pixel distribution across a second range of brightnesses, the second range of brightnesses greater than the first range of brightnesses, wherein the color-corrected image is generated based at least in part on the updated pixel values.

9. The method of claim 1, wherein determining the lens position for the sensor comprises:
adjusting one or more parameters of a focus value operation, wherein the lens position of the sensor is determined based at least in part on the adjusting.

10. The method of claim 9, wherein the one or more parameters of the focus value operation comprises a focus value maximum threshold, a focus value minimum threshold, a focus value bandpass filter, or a combination thereof.

11. The method of claim 1, wherein outputting the color-corrected image comprises:
writing the color-corrected image to a memory component of the device;
displaying the color-corrected image; or; and
transmitting the color-corrected image to a second device.

12. An apparatus for image processing, comprising:
a processor,
memory in electronic communication with the processor; and
instructions stored in the memory and executable by the processor to cause the apparatus to:
detect a spotlight in an exposure of a scene based at least in part on one or more auto-exposure statistics for the exposure;
determine a lens position for a sensor of the apparatus based at least in part on detecting the spotlight;
capture, by the sensor and based on the lens position, a pixel array representing the scene;
adjust image processing parameters of an automatic white balance stage or a contrast enhancement stage of an image processing pipeline based at least in part on the detected spotlight;
generate a color-corrected image by passing the pixel array through the image processing pipeline; and
output the color-corrected image.

13. The apparatus of claim 12, wherein the instructions are further executable by the processor to cause the apparatus to:
generate a preview of the exposure based at least in part on the lens position; and
display the preview of the exposure prior to capturing the pixel array.

14. The apparatus of claim 12, wherein the instructions to detect the spotlight are executable by the processor to cause the apparatus to:
divide the exposure of the scene into a plurality of regions, each region comprising a respective set of pixels;
determine at least one auto-exposure statistic for each region; and
compare each auto-exposure statistic to a threshold, wherein the spotlight is detected based at least in part on the comparing.

15. The apparatus of claim 12, wherein the instructions to adjust the image processing parameters of the contrast enhancement stage are executable by the processor to cause the apparatus to:
generate a pixel distribution for the pixel array, wherein the pixel distribution indicates a number of pixels having respective brightnesses across a first range of brightnesses; and
update pixel values for one or more pixels of the pixel array by stretching the pixel distribution across a second range of brightnesses, the second range of brightnesses greater than the first range of brightnesses, wherein the color-corrected image is generated based at least in part on the updated pixel values.

16. The apparatus of claim 12, wherein the instructions to determine the lens position for the sensor are executable by the processor to cause the apparatus to:
adjust one or more parameters of a focus value operation, wherein the lens position of the sensor is determined based at least in part on the adjusting.

17. An apparatus for image processing, comprising:
means for detecting a spotlight in an exposure of a scene based at least in part on one or more auto-exposure statistics for the exposure;
means for determining a lens position based at least in part on detecting the spotlight;
means for capturing, based on the lens position, a pixel array representing the scene;
means for adjusting image processing parameters of an automatic white balance stage or a contrast enhancement stage of an image processing pipeline based at least in part on the detected spotlight;
means for generating a color-corrected image by passing the pixel array through the image processing pipeline; and
means for outputting the color-corrected image.

18. The apparatus of claim 17, further comprising:
means for generating a preview of the exposure based at least in part on the lens position; and
means for displaying the preview of the exposure prior to capturing the pixel array.

19. The apparatus of claim 17, wherein the means for detecting the spotlight comprises:
means for dividing the exposure of the scene into a plurality of regions, each region comprising a respective set of pixels;
means for determining at least one auto-exposure statistic for each region; and
means for comparing each auto-exposure statistic to a threshold, wherein the spotlight is detected based at least in part on the comparing.

20. The apparatus of claim 17, wherein the means for adjusting the image processing parameters of the contrast enhancement stage comprises:
means for generating a pixel distribution for the pixel array, wherein the pixel distribution indicates a number of pixels having respective brightnesses across a first range of brightnesses; and
means for updating pixel values for one or more pixels of the pixel array by stretching the pixel distribution across a second range of brightnesses, the second range of brightnesses greater than the first range of brightnesses, wherein the color-corrected image is generated based at least in part on the updated pixel values.
